(19) United States
(12) Patent Application Publication
(10) Pub. No.: US 2017/0083930 A1
(43) Pub. Date: Mar. 23, 2017

(54) TRANSACTION-BASED REWARDS OPTIMIZATION AND INTELLIGENT ACCOUNT SELECTION

(71) Applicants: Kaushik Nagaraj, King of Prussia, PA (US); Gustavo Marin, Blaine, WA (US)

(72) Inventors: Kaushik Nagaraj, King of Prussia, PA (US); Gustavo Marin, Blaine, WA (US)

(21) Appl. No.: 14/857,771

(22) Filed: Sep. 17, 2015

(51) Int. Cl. G06Q 30/02; G06Q 20/38; G06Q 50/00; G06Q 20/22

(52) U.S. Cl. CPC G06Q 30/0207; G06Q 20/227; G06Q 20/387; G06Q 50/01

(57) ABSTRACT

A system for transaction-based rewards optimization and intelligent account selection comprising an optimization manager that receives transaction information and rewards program information, compares transaction information with rewards program information, and produces optimized rewards program selections, and a dynamic priority subsystem that orders the optimized rewards program selections based on priority preferences, and a method for transaction-based rewards optimization and intelligent account selection.

### CROSS-REFERENCE TO RELATED APPLICATIONS

None.

### BACKGROUND OF THE INVENTION

Field of the Art

The disclosure relates to the field of electronic transactions, and more particularly to the field of intelligently selecting rewards-based accounts for use.

Discussion of the State of the Art

In the field of electronic transactions, it is a common practice for account providers such as financial institutions or membership clubs to incentivize user participation through the use of “rewards programs”, wherein users may accrue incentivized value based on their participation, for example earning “points” per dollar spent using a particular credit card or at a particular merchant. It is not uncommon for users to collect numerous membership programs in this fashion, each with a respective reward incentive or participation bonus. When a user is conducting a transaction, they have to select an account or card to use, generally having to decide at that time which rewards program to utilize for the transaction.

What is needed is a means to automatically track and analyze a user's cards and accounts, and intelligently determine ideal accounts to use on a per-transaction basis for the maximum benefit to the user, as well as a way to assist users in reaching specific program goals in an economical fashion.

### SUMMARY OF THE INVENTION

Accordingly, the inventor has conceived and reduced to practice, in a preferred embodiment of the invention, a system and method for transaction-based rewards optimization and intelligent account selection.

According to a preferred embodiment of the invention, a system for transaction-based rewards optimization and intelligent account selection, comprising an optimization manager comprising at least a plurality of programming instructions stored in a memory and operating on a processor of a computing device and configured to receive at least a plurality of transaction information and a plurality of rewards program information via a network, the rewards program information comprising at least a plurality of user account details, and configured to compare at least a portion of the transaction information with at least a portion of the rewards program information, and configured to produce a plurality of optimized rewards program selections based at least in part on the comparison results; and a dynamic priority subsystem comprising at least a plurality of programming instructions stored in a memory and operating on a processor of a computing device and configured to receive at least a plurality of optimized rewards program selections and at least a plurality of priority preferences, and configured to order at least a portion of the optimized rewards program selections based at least in part on at least a portion of the priority preferences, is disclosed.

According to another preferred embodiment of the invention, a method for transaction-based rewards optimization and intelligent account selection, comprising the steps of receiving, at an optimization manager comprising at least a plurality of programming instructions stored in a memory and operating on a processor of a computing device and configured to receive at least a plurality of transaction information and a plurality of rewards program information via a network, the rewards program information comprising at least a plurality of user account details, and configured to compare at least a portion of the transaction information with at least a portion of the rewards program information, and configured to produce a plurality of optimized rewards program selections based at least in part on the comparison results, a plurality of transaction information; receiving a plurality of rewards program information; comparing at least a portion of the plurality of rewards program information against at least a portion of the plurality of transaction information; producing at least a plurality of optimized rewards program selections based at least in part on at least a portion of the comparison results; and presenting at least a portion of the optimized rewards program selections to a user, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system architecture for optimizing the use of rewards-based accounts, according to a preferred embodiment of the invention.

FIG. 6 is an illustration of a plurality of exemplary rewards account relationships, illustrating relationships between accounts and rewards program points that may be collected.

FIG. 7 is an illustration of a plurality of exemplary rewards account relationships, illustrating relationships between accounts that permit exchange of program points.

FIG. 8 is a block diagram illustrating an exemplary priority ranking system for use in selecting a rewards account for use by a dynamic priority subsystem, according to an embodiment of the invention.

FIG. 9 is a flow diagram illustrating an exemplary method for account selection decision-making, according to a preferred embodiment of the invention.

FIG. 10 is a flow diagram illustrating an exemplary method for splitting a single transaction among multiple users, using intelligent account selection for each participating user.

FIG. 11 is a diagram of an exemplary graphical user interface for a transaction-based rewards optimization system, showing a user participation screen and a menu interface.

FIG. 12 is a diagram of an exemplary graphical user interface for a transaction-based rewards optimization system, showing a wallet view and a decision engine screen.

FIG. 13 is a diagram of an exemplary graphical user interface for a transaction-based rewards optimization system, showing a bill split interface and a transaction completion summary view.

### DETAILED DESCRIPTION

The inventor has conceived, and reduced to practice, in a preferred embodiment of the invention, a system and method for transaction-based rewards optimization and intelligent account selection.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

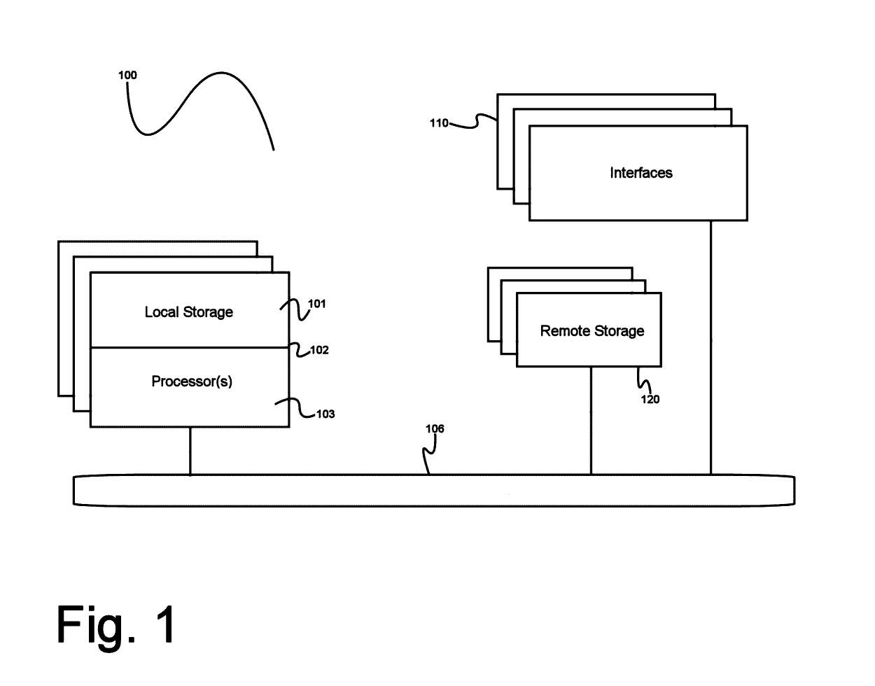

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

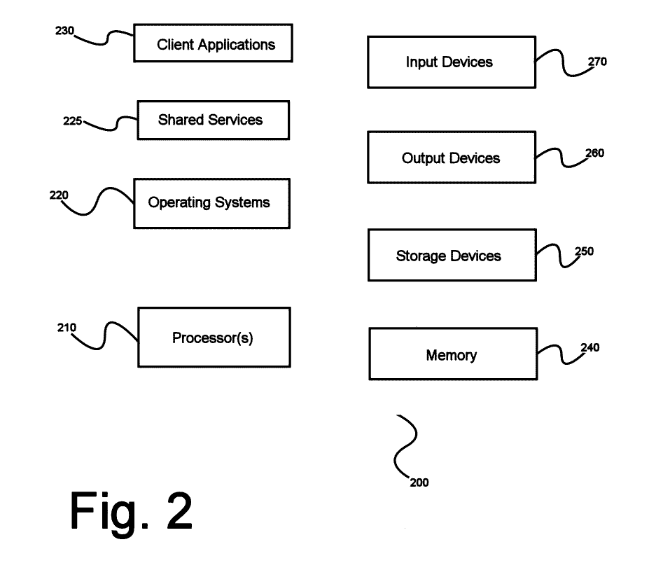

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

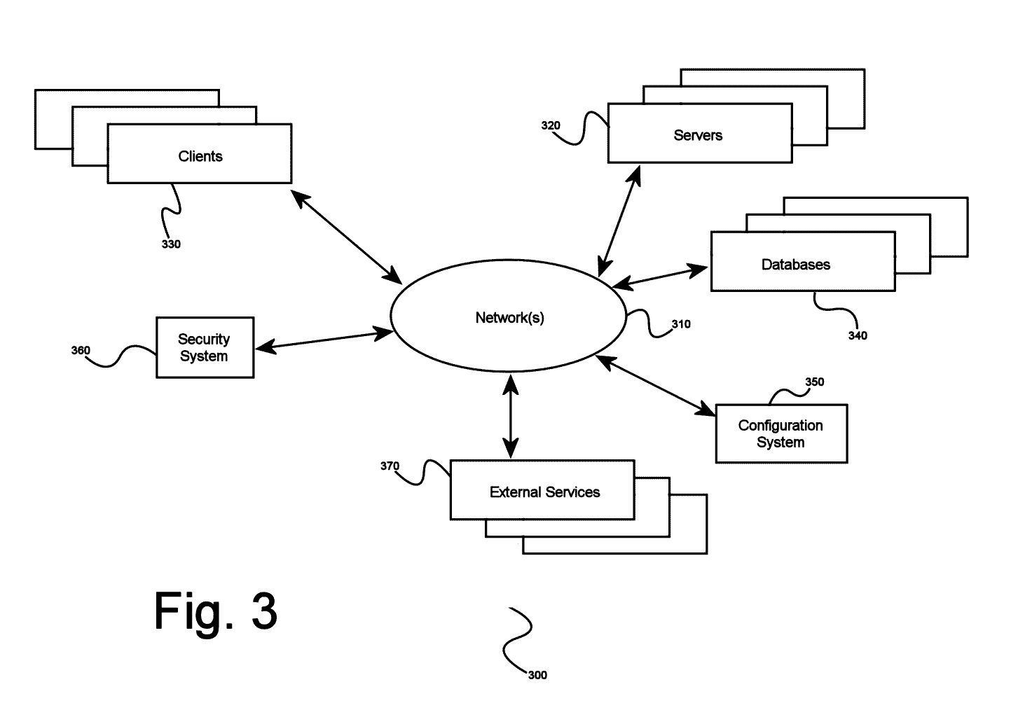

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

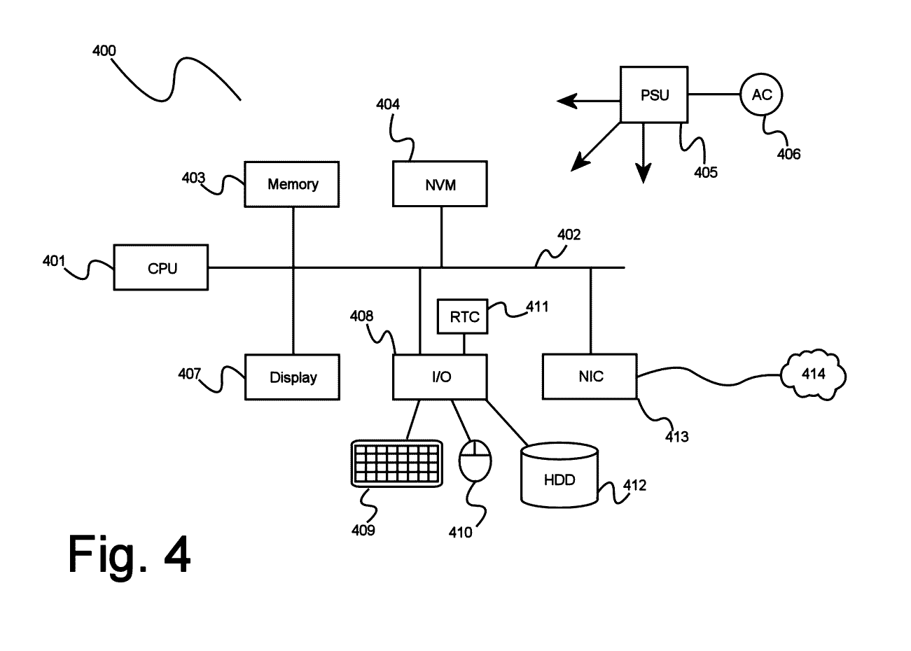

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

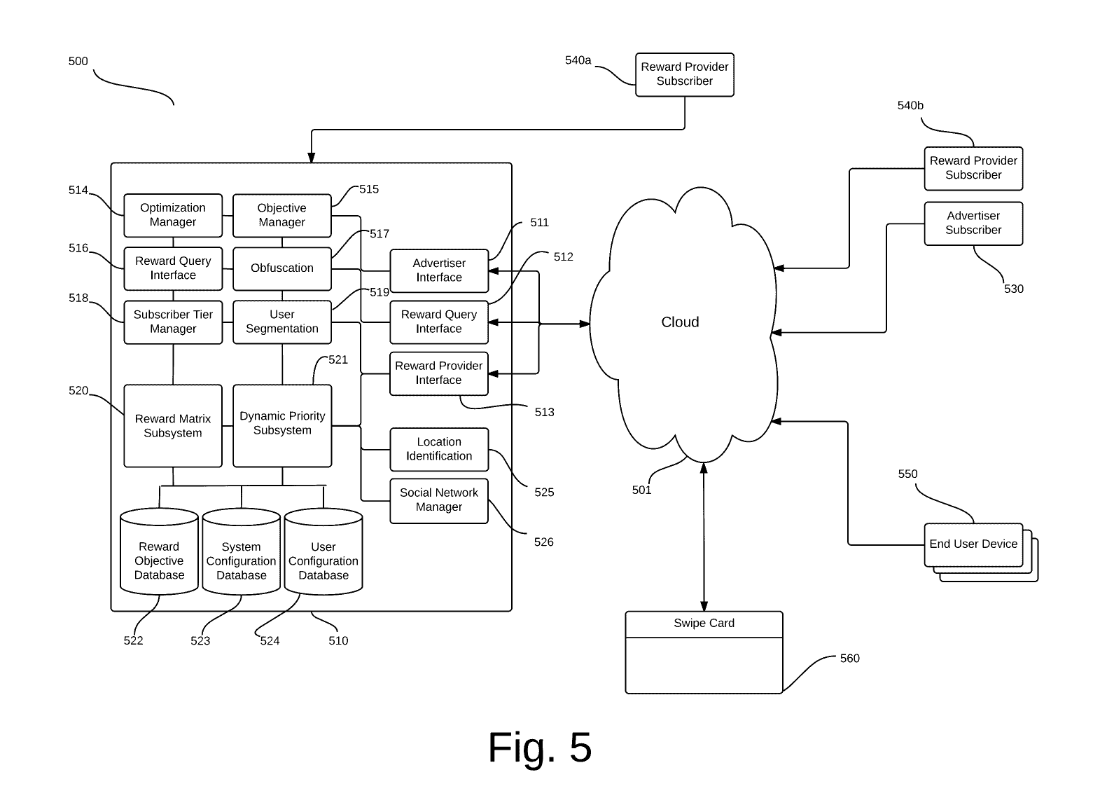

FIG. 5 is a block diagram illustrating an exemplary system architecture 500 for optimizing the use of rewards-based accounts, according to a preferred embodiment of the invention. According to the embodiment, a rewards optimization system 510 may operate a plurality of communication interfaces to interact via a network, for example an advertiser interface 511 may receive input via a network 501 from a plurality of advertiser subscribers 530 (for example, to promote a new card or account type, or a new rewards program), a reward provider interface 513 may receive interaction from a plurality of rewards provider subscribers 540a-b (for example, to configure a rewards program such as defining reward values or membership levels), or a reward query interface 512 may receive interaction from a plurality of end-user devices 550 operated by a plurality of end users (generally card or account holders, for example to check on their rewards program status such as current membership level or points accrued). According to the embodiment, a “subscriber” may refer to any individual or entity that is participating in a rewards optimization program, whether a financial institution or other account or card provider (for example, card providers that are not necessarily financial institutions, such as SIMPLE™ or PAYPAL™) or an advertiser. Further according to the embodiment, an optimization system 510 may be operated by a rewards provider 540a, for example to encourage participation in their own rewards programs, or may optionally be operated by a third-party in a software-as-a-service (SaaS) operational model, where an SaaS provider may operate system 510 to provide optimization services to a number of rewards providers as clients.

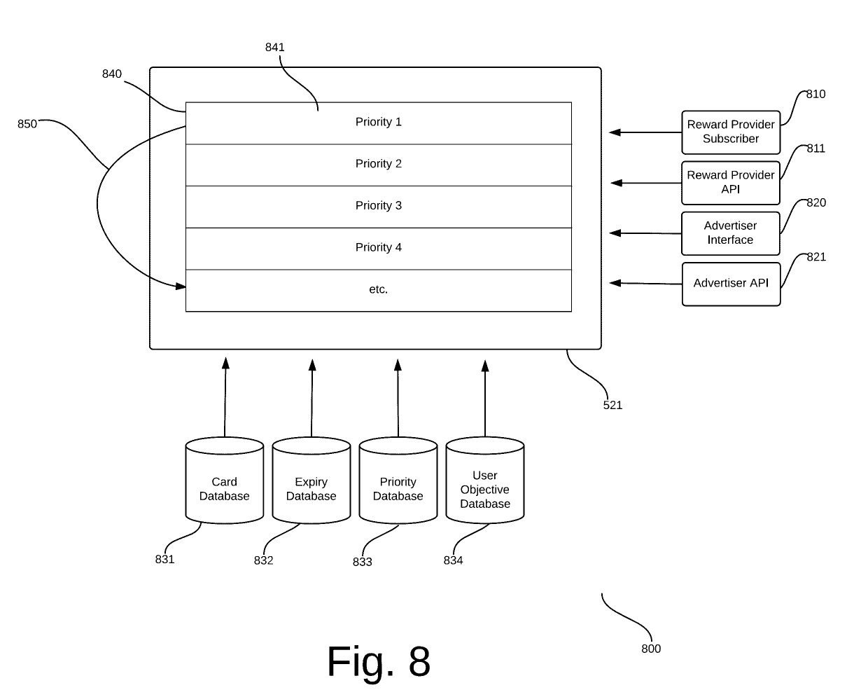

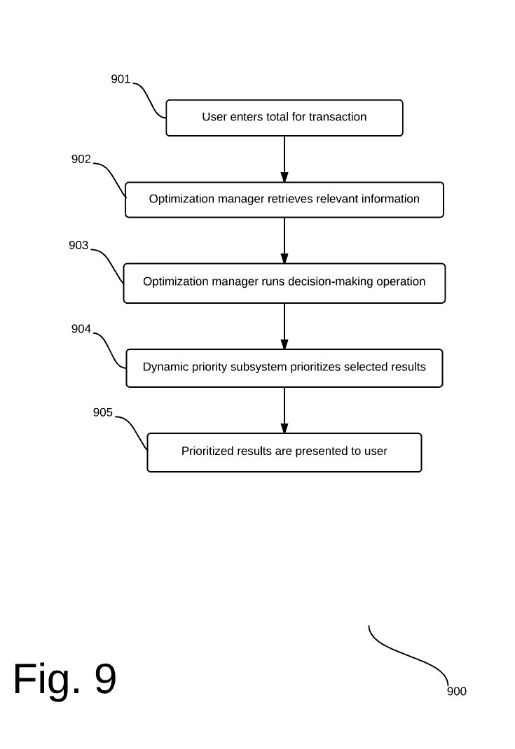

Further according to the embodiment, system 510 may operate a number of components to facilitate optimization operations. For example, an optimization manager 514 may be used to find ideal rewards programs for particular end-user (such as based on their spending or saving habits) or to identify ideal rewards programs or accounts for use (for example, on a per-transaction or per-time basis, generally to maximize the rewards accrual for a given transaction or to progress toward a specific goal set by an end-user, as described below referring to FIGS. 8-9). Optimization manager 514 may also consider prepaid or gift cards, for example to rank a gift card above any credit or debit cards at an appropriate vendor, so a user may be reminded that they have a vendor-specific balance that they may wish to utilize before spending any “real money”.

An objective manager 515 may be used to manage user-defined goals, for example if a user wishes to save points in a particular rewards program so they may exchange them for a plane ticket. Additionally, objective information may be used in optimization processing to determine a “most efficient path” for a user to achieve their goals, by selecting accounts or cards for use in an ideal manner. For example, if a user wishes to take a vacation within a specific time window, objective manager 515 may select accounts based on that goal to ensure the user accrues an appropriate number of relevant rewards points within the allotted time, so they may be exchanged for the plane ticket and the vacation may take place when planned. Additionally, more complex optimization may be performed, to select a specific airline or travel agency to maximize the return on a rewards redemption, for example if points within a particular program may be counted as double their face value when exchanged for airline miles with a particular airline, or if point bonuses are awarded when redeemed at specific times or in a specific manner, or other such redemption optimization. In this manner, a user may set specific goals and use optimization to achieve their goals in the most efficient manner, while also receiving the greatest payout for their rewards redemptions as well as the most efficient rewards accrual. Additionally, objective manager 515 may identify areas where a user's goal may not be met, but can be substituted for a different goal or redemption. For example, if a user wishes to collect rewards points toward airfare for a planned trip, it may be that their spending habits are insufficient for this goal to be met even in an optimal usage scenario. Instead, an objective optimization manager 514 may suggest alternative goals to assist the user with optimized account or card usage, for example suggesting airfare where their rewards may be used for an upgrade, or hotels relevant to the planned trip (even if the airfare itself must be paid for out-of-pocket). Additionally, goals may be intelligently updated or new alternatives presented if circumstances change—for example, if the terms of a rewards program are altered, or a user's spending habits change, they may be prompted to update a goal or choose a new alternative objective to pursue during optimization.

In another embodiment, obfuscation engine 516 may be used to make user-identifying information obscure or unclear to, for example, advertiser subscriber 530 while keeping at least goal information visible. For example, end-user device 550 may have a goal configured to travel to a particular destination where a certain amount of reward points are required. By removing user device 550's user-identification information, any goal information may be provided to advertiser subscriber 530 without identifying the actual user. In the present embodiment, an advertiser subscriber 530 may be, for example, a credit card issuer or some other establishment that provides rewards-based cards (e.g. debit card, gift card, credit card, and the like) or currency instruments. In this regard, an advertiser can customize offers to user device 550 to help the end-user reach the particular goal as calculated by, for example, objective manager 515. For example, advertiser subscriber 530 may offer a new credit card with a sign-up bonus that allows the user to accelerate reward collection and thus reach the particular goal much quicker. By obfuscating end-user device 550's user information, end-user device 550 is ensured that no user-identifying information will end up to advertiser subscriber 530, thus limiting the ability for advertiser subscriber 530 to contact end-user device 550 directly. For example, advertiser subscriber may only contact end-user device 550 through system 500 only thereby sparing end-user device 550 typical concerns of spam, unsolicited contact, fraud, etc. Obfuscation engine 516 thus allows a higher adoption whereby users allow advertisements and offers from advertiser subscriber 530. Further, by obfuscating user-identifying information, advertiser subscriber 530 may have an increased opportunity to deliver customized offers specific to end-user device 550's goals.

According to an embodiment, a reward query interface 517 may be used to process queries on rewards information, for example if an end-user wishes to check their balance or membership tier with a particular rewards program, or if an optimization operation requests up-to-date rewards information for use in making a determination (for example, selecting an optimum account for a transaction). A subscriber tier manager 518 may be used to process membership tiers or levels, for example in a rewards program that may have different accrual rates or redemption options for users based on a subscription level (for example, “gold members get double points”, or similar programs). A user segmentation engine 519 may be used to associate individual users with rewards program information such as membership tiers or account balances, in order to maintain a stateful representation of each user's membership and account information for use in optimization, as well as to group users into categories or “tiers” for organizational purposes (for example, to configure operation according to particular user groups as a “baseline” configuration) or to facilitate interaction between users. For example, users may be grouped according to spending habits and provided with a social interaction interface to interact with other users within their group, such as to provide a competitive rewards comparison or other forms of gamification to encourage user participation or to aid users in directing behavior towards particular goals. Another way user may interact may be the exchange of gift cards, for example users may configure “desirable” or “undesirable” vendors or cards, and those preferences may be compared against other users' submissions. A user may then be shown a selection of other users who desire their unwanted gift cards, or who have a card for a vendor they prefer. Users may then offer to exchange gift card balances or to purchase gift cards from one another (for example, using non-gift balances).

An additional operation of a user segmentation engine 519 may be to also organize or group transactions for a particular user, for example to separate “personal” and “work” transactions. This may be done based on user-defined preferences such as if a user chooses to classify all fuel expenses as a “work” transaction type (for example, for a user who drives a company vehicle), or automatically by analyzing the transactions such as to identify the type of vendor or what account was used to complete a transaction, for example whether a user used a company credit card or a personal debit card.

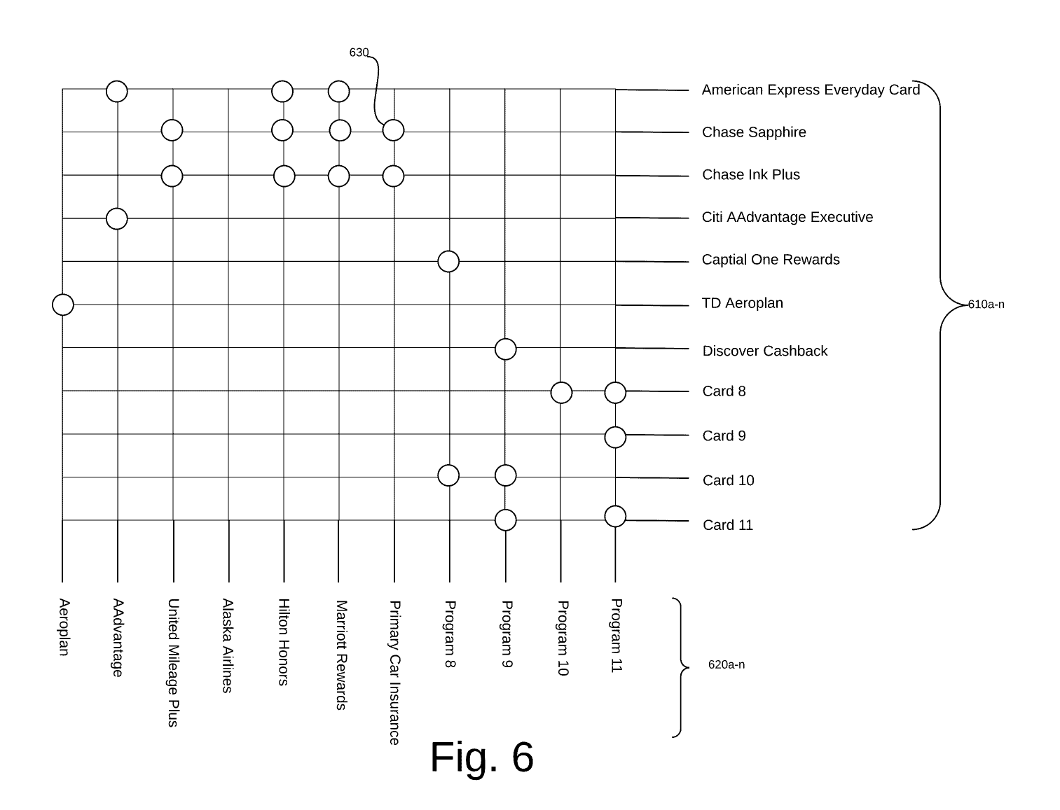

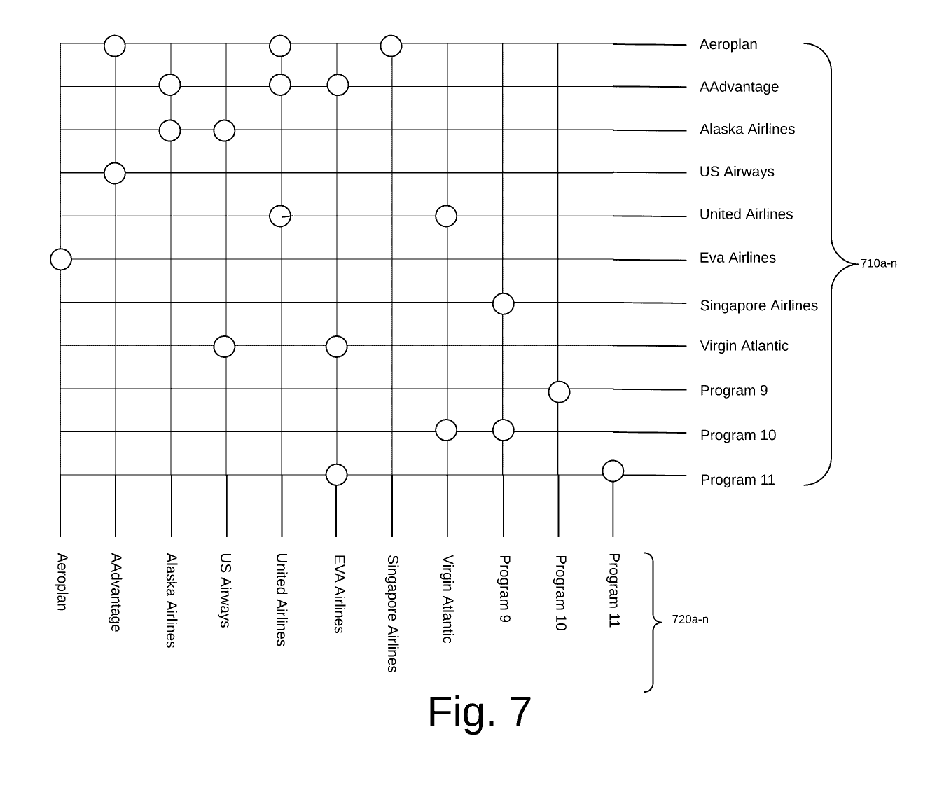

A reward matrix subsystem 520 may be used to identify relationships between rewards programs or providers, or between programs and goals, as described below (referring to FIGS. 6-7). A dynamic priority subsystem 521 may be used to manage an ordered list of prioritized accounts, programs, cards, membership tiers, or other relevant information for use during optimization operations, as described below (referring to FIG. 8).

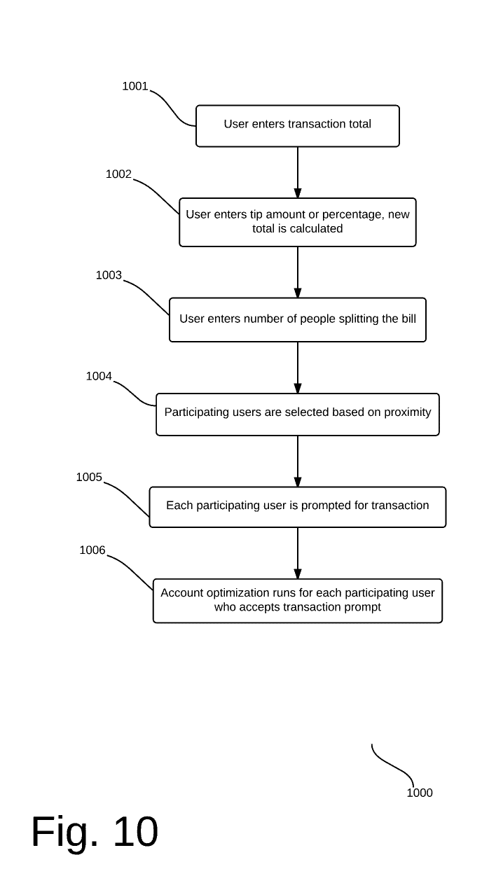

Further according to the embodiment, a plurality of data stores may be operated by system 510, for example a reward objective database 522 may store and provide information about user-defined or automatically-selected objectives, such as specific redemption goals or preferred accrual types or rates (for example, if a user configures optimization to prefer airlines miles over cash-back rewards). A system configuration database 523 may store and provide a variety of configuration and operational information, for example logs of optimization operations, or configured operational parameters that define behavior. A user configuration database 524 may store and provide a variety of user-based information, such as per-user configurations (for example, if a user configures particular display settings for interaction on their device), or non-rewards-based user configuration or preferences. Additionally, system 510 may utilize a variety of location identification means 525, for example receiving location-based information from a geographic location of a user's device (if a user has configured such behavior or provided consent), or inferred location information such as using a user's IP address during a particular transaction, or other means of locating a particular user during operation. Location information may be utilized in a variety of ways during an optimization process, for example to identify location-based offers (such as physical vendors that may offer promotional rewards rates or programs), or to identify nearby contacts such as for use in splitting a transaction between users (such as friends or business colleagues splitting a meal bill, for example) operation, as described below (referring to FIG. 10), and/or, specific reward programs which may correspond to an establishment at the geographic location.

According to the embodiment, a plurality of advertisers 530 may present offers such as new rewards programs, limited-time bonuses, or specific redemption promotions to a user, and these offers may be utilized in an optimization process such as to present specific offers to a user for consideration during an objective-selection process, or to utilize particular offers when making an optimization determination to benefit the user (for example, selecting an account for a particular transaction, because that account currently has an active offer). Additionally, advertisers may present offers based on a variety of user-specific criteria, such as location (offers only valid for users in a particular area), time-based criteria (such as limited-time offers with an expiration window), offers based on account or payment history or creditworthiness (such as based on a user's FICO credit score or other scoring or grading criteria), or any other means of identifying a user and associating specific offers or promotions with them in a personalized or targeted fashion. As another example, if a participating user is in a foreign location, offers may be tailored to accommodate foreign transaction fees, selecting lower transaction fees when determining an optimum card for a particular transaction or when prioritizing options to present to a user for selection.

According to the embodiment, an end-user device 550 may interact with system 510 via a network, for example to select redemption objectives, configure account information, or configure their optimization preferences via an online interface accessible via a web browser, or a system operating on their device (such as a smartphone or tablet computing device, for example). A user's particular account card 560 (such as, for example, a credit or debit card associated with a plurality of rewards programs, or a membership or loyalty card) may then interact with system 510, for example to report a transaction in progress or after completion, or to report any changes to account information (such as a new credit card having a different security code or expiration date), or any other information that may be relevant to an optimization process. Additionally, location or vendor information may be provided for use, for example to select particular cards or types of cards based on the location or type of a vendor where a transaction is occurring, such as to select a card with lower transaction fees (for example to reduce foreign transaction fees as described previously or to reduce fees based on the type of transaction or vendor), or to select a card type best suited to a particular transaction, optionally based at least in part on user-defined preferences (such as to avoid using debit cards at gas stations).

According to the embodiment, social network manager 526 creates connections and associations between a plurality of end-user devices 550 connecting other users (for example, family, friends, associates, colleagues, and the like) of system 500 to create an association. In a preferred embodiment, a first end-user device 550 may be used by an end-user to input information (for example, a telephone number, email address, name, etc.) identifying a second end-user device 550 that may be configured in system 500. If second end-user device 550 is not registered, then an invitation may be sent to second end-user device 550 (for example, via email, text message, an automated call via interactive voice response, or some other electronic means of communications). Social network manager 526 then configures a social connection between first end-user device 550 and second end-user device 550 into the user configuration database 524. In this regard, a plurality of connected users 550 may share information, objectives and goals (for example, a goal of achieving enough reward for a particular destination via reward travel), configured cards (for example, credit cards, gift cards, etc.). In some embodiments, a user may make a particular item available for use and/or purchase by other connection. For example, a first user of a first user device 550 may have a gift card for a restaurant (for example, Chipotle™) with a face value of $50. In this regard, perhaps the first user may not desire to dine at Chipotle™ and places the gift card available for purchase at a reduced price of $40. In this regard when location identification 525 determines that a second user of a second user device 550 (who may have been connected to a first user via social network manager 526) is inside a Chipotle™ restaurant with a pending transaction, priority subsystem 800 may place the gift card as priority 1 841, that is, the best card for use in the pending transaction at the, for example, Chipotle™ restaurant. In this regard, optimization manager determines which credit card of the second user would be best to purchase the gift card, and once accepted, via the second user device 550, the purchase transaction of the gift card is executed and the gift card becomes available for use.

In some embodiments, the first user and the second end-user devices 550 are not connected via social network manager 526 and an offer to purchase the gift may still be available based on a pre configuration via user configuration database 524. In another embodiments, when location identification 525 determines that a second user device 550 is within a predefined proximity of a restaurant where there may be an available gift card available for purchase (for example, a gift card that presents a potentially “incredible” and a potentially “desirable” deal), the second user may be presented with an offer to purchase the gift card via the second user device 550 as an incentive to dine at a restaurant where there may be a good deal.

In yet another embodiment, a second user device 550 may indicate a “restaurant wish list” via objective manager 515 and stored in user configuration database 524. In this regard, if and when a gift card corresponding to a preconfigured “wish list restaurant” becomes available, the second user device 550 may be notified of the available gift card.

### Detailed Description of Exemplary Embodiments

FIG. 6 is an illustration of a plurality of exemplary rewards account relationships, illustrating relationships between accounts and rewards program points that may be collected. According to the embodiment, a reward matrix subsystem 520 may identify a plurality of relationships between various rewards programs, accounts, providers, redemption types, or other data relationships for use in optimization. As illustrated, a plurality of rewards providers 610a-n may be compared against a plurality of secondary rewards providers 620a-n, to identify relationships such as program point or redemption exchange rates. For example, as illustrated, a specific exchange relationship may be identified 630 wherein a “Chase Sapphire” rewards program may permit a user to exchange accrued points at a specified rate (for example, a 1:1 exchange or a “two for one” exchange, a variable rate, or other exchange terms) for a number of points with a primary car insurance provider. In this manner, a variety of relationships may be identified and used in optimization, for example to assist a user in achieving a selected redemption objective or to optimize rewards on a per-transaction basis. For example, a particular rewards account may be selected for a transaction if it has a high rewards accrual rate and a good exchange rate with a rewards program a user has selected as “preferred”, for example airfare miles. In another example, a rewards account may be selected because it allows rewards exchange for points that are more immediately useful to a user, if there is no card or account that directly accrues the desired points (for example, points with an insurance provider for which the user does not hold a provider-specific card). In this manner, complex selection criteria may be utilized when optimizing a transaction or an objective.

In another embodiment, 610h may be a card associated through social network manager 526 (for example, a spouse's card, a gift card for sale, etc.). In this regard, the process above (referring for FIG. 6) may use an associated card to optimize priority by dynamic priority subsystem 521.

FIG. 7 is an illustration of a plurality of exemplary rewards account relationships, illustrating relationships between accounts that permit exchange of program points. According to the embodiment, a plurality of rewards providers 710a-n may allow a user to directly redeem rewards points with a plurality of alternate rewards programs 720a-n, rather than exchanging points between programs. For example, rather than a user accruing rewards points with a provider and then exchanging them for points with a second provider, they may instead accrue a number of points with a provider and then at a later time redeem them with a second provider, for example to redeem points for “cash back” or airline miles, rather than “converting” them between rewards programs and potentially losing rewards due to exchange rates or fees.

FIG. 8 is a block diagram illustrating an exemplary priority ranking system 800 for use in selecting a rewards account for use by a dynamic priority subsystem 521, according to an embodiment of the invention. According to the embodiment, a dynamic priority subsystem 521 may receive a plurality of information from a variety of sources, for example including databases or other data storage or “live” data from a rewards provider 810 (for example, rewards program information such as new promotions or program terms), optionally provided via a software application programming interface (API) 811 (for example, a rewards provider may utilize an API to integrate a rewards program system with an optimization platform according to the embodiment, to provide information automatically), or an advertiser 820 optionally via an API 821, for example to receive new promotions or offers as they are made available.

In some embodiments, priority ranking system 800 uses location information of a first user device 550 from location identification 525 to optimize priority list 840. In this regard, dynamic priority subsystem may suggest a different priority list based on the current location of first user device 550, for example, if first user device 550 is in a Macy's™ store, optimization manager 514 in conjunction with dynamic priority subsystem 521, may suggest, for example, a Macy's™ credit or gift card that may have been previously configured in card database 831.

Further according to the embodiment, stored information may be received from a card database 831, for example card-specific information such as a user's known active cards (for example, a user may selectively enroll their cards in an optimization program, in a process known as “onboarding”, to make them available for use in an optimization process). An expiry database 832 may provide a plurality of card or account expiration information, or expiration information for specific rewards program offers such as temporary promotions or rates. A priority database 833 may provide a plurality of known user-specific priority information, such as “prefer airline miles” or “avoid this account” or “do not use this account unless absolutely necessary” (for example, if point expiration associated to the card are about to expire), or any other such user-specific priority preference. A user objective database 834 may provide a plurality of user-defined objectives, such as redemption goals as described previously (referring to FIGS. 5-7), for example if a user has specified that they want to achieve a specific redemption goal within a specific timeframe.

According to the embodiment, the various information received from sources as described above may then be used by a dynamic priority subsystem 521 to determine an ordered-list ranking 840 of cards, accounts, programs, rewards types, or other such information entities, and may then make this ordered-list available for use in selecting a specific entity for use. For example, after processing a plurality of information it may be determined that a specific card should be given a higher priority than others, based on its relevance to a user's specific objectives and preferences (such as ranking a gift card higher because it's accepted at a particular vendor, or a credit card that offers bonus rewards at a specific vendor). This card may be placed at the top 841 of a priority list 840, so that it may be presented first when appropriate. For example, in automated operation, the highest-priority card or account for a particular transaction may be automatically selected and used, such as during an electronic transaction where a user may not need to present a physical card to close the transaction. In a transaction where a user must manually select a card or provide account information, such as checking out at a retail point-of-sale (POS) or when completing an online transaction where they must select a card to provide to a merchant, they may be presented with prioritized list 840 and directed toward the highest-ranked card or account to optimize rewards for this transaction, while retaining the option to instead select a different card (for example, if they have changed their preferences or goals but have not yet configured the change in an optimization system, or if they are not carrying a particular card with them at the moment). Further according to the embodiment, as new information becomes available (such as when a promotion expires, a user's credit score changes, an account is opened or closed, or program terms change), a priority list may be updated, and an account may shift in ranking 850 in real-time based on new information, so that at any given moment the relevance of a priority list 840 may be preserved by using the most recent information as soon as it is received (that is, the list is always up-to-date). In some embodiments, prioritized list 840 may be arranged based on user objective as determined by objective manager 515. For example, even though in a particular transaction, a card selected as priority 1 841 may not be a maximization of rewards but rather to accelerate reward accumulation to a particular user objective. In another embodiment, optimization manager 514 may select a low-priority card as a priority 1 841 card whose, for example, reward expiration date is drawing near in a situation where using the card may extend the expiration date by, for example, 12 months. In this regard, a small transaction, for example, a purchase of a small currency amount, optimization manager 514 may choose a low priority card to keep the associated rewards active.

FIG. 9 is a flow diagram illustrating an exemplary method 900 for account selection decision-making, according to a preferred embodiment of the invention. In an initial step 901, a user may enter transaction information via an interface on their device (for example, a software application for interacting with a rewards optimization system, or a web-based interface accessible via a browser operating on their device), such as a transaction total or vendor or purchase type information (for example, selecting “groceries” from a category list view). In a next step 902, an optimization manager may collect relevant information, such as including (but not limited to) the user's account or card types, membership information such as membership levels and account standing, rewards program enrollment or terms, rewards balances, user-defined preferences or objectives, or a user's location information. In a next step 903, the optimization manager may run a decision-making operation based at least in part on collected information, to determine a number of optimum cards or accounts for use based on the information inputs. In a next step 904, results may be provided to dynamic priority subsystem, which may prioritize the results based on known information (as described previously, referring to FIG. 8). In a final step 905, a list of prioritized results may be presented to the user, for example indicating a highest-priority result to encourage the user to select the ideal card or account for the current transaction, while also providing a number of alternatives if possible (for example, no alternatives may be shown if the user has only onboarded a single account into an optimization system).

FIG. 10 is a flow diagram illustrating an exemplary method 1000 for splitting a single transaction among multiple users, using intelligent account selection for each participating user. In an initial step 1001, a user may enter transaction information such as (for example, in a dining transaction) the total for the bill. In a next step 1002 the user may optionally specify a tip amount or percentage, and a new cumulative total for the transaction is calculated. In a next step 1003, the user may select a number of other people with whom to split the total. In a next step 1004, participating users may be automatically determined based on their proximity to the user whereby location identification 525 identifies and suggests a plurality of end-user devices 550 within a short proximity to, for example, split the total of the bill. In this regard, the plurality of end-user devices 550 may be prompted to participate in the transaction in a next step 1005. In a final step 1006, an optimization operation (such as described previously, referring to FIG. 9) may be performed for each participating user that accepts the prompt to participate in the transaction. In this manner, each participating user may have their own card or account selections optimized for them, rather than using a single optimization for an entire transaction when multiple parties may be involved.

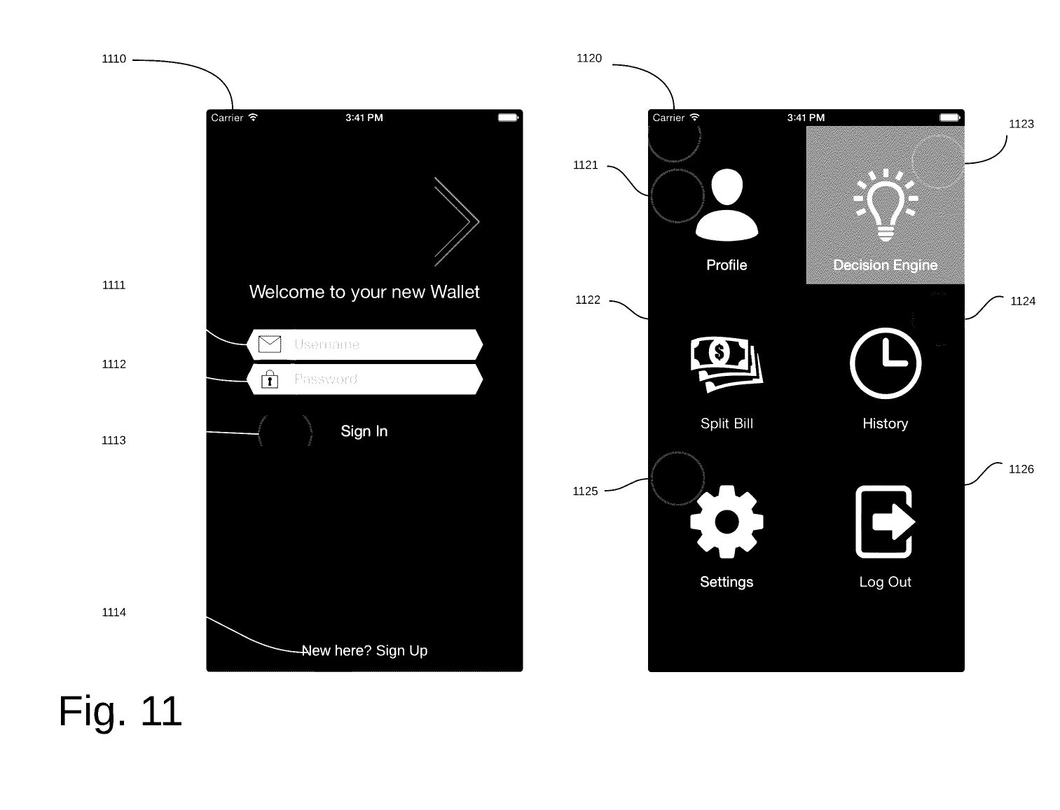

FIG. 11 is a diagram of an exemplary graphical user interface for a transaction-based rewards optimization system, showing a user participation screen 1110 and a menu interface 1120. Such an application may be operated as a front-end for an optimization system according to the invention, to enable a user to participate and configure their settings for operation. In a user participation screen 1110, a user may be presented with interactive elements such as text fields where they may provide their login credentials, for example a username 1111 and password 1112, and a button or other interactive element to login 1113 to an optimization application. If a user is not yet participating, they may be presented with an optional element 1114 to sign up and participate, for example by providing personal details and account or card information for use in optimization.

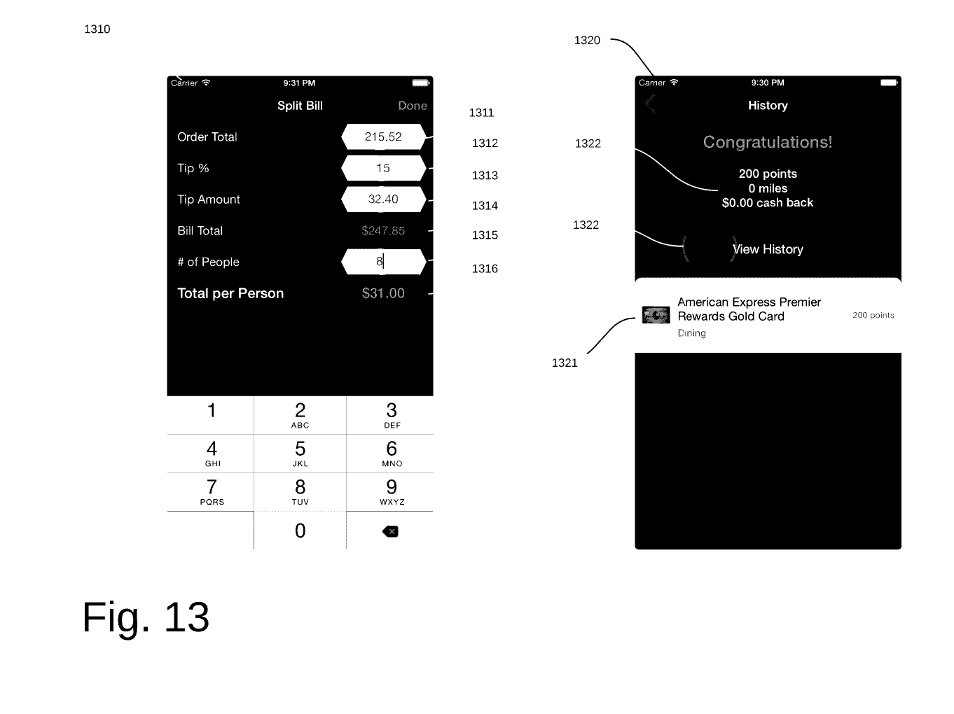

In a menu interface 1120, a user may be presented with a number of interactive elements corresponding to other portions of an application or pages of a web-based interface, for example such as a settings page 1125 where they may configure app-specific or account-specific configuration preferences such as notification settings, or a button to log out of an interface 1126. Additional menu options may include (but are not limited to) a user's profile configuration 1121, where they may configure various profile information such as personal information (for example, contact or demographic information), a bill splitting interface 1122 where a user may access a bill splitting interface (as described below, referring to FIG. 13), or a history view 1123 where a user may view recent or historical transaction, for example to review their spending or to manually audit the operation of an optimization system (for example, to confirm that the card they wanted to use is the one that was selected, or to review the charges from a vendor after they authorized a transaction for an unspecified amount, such as at a gas pump).

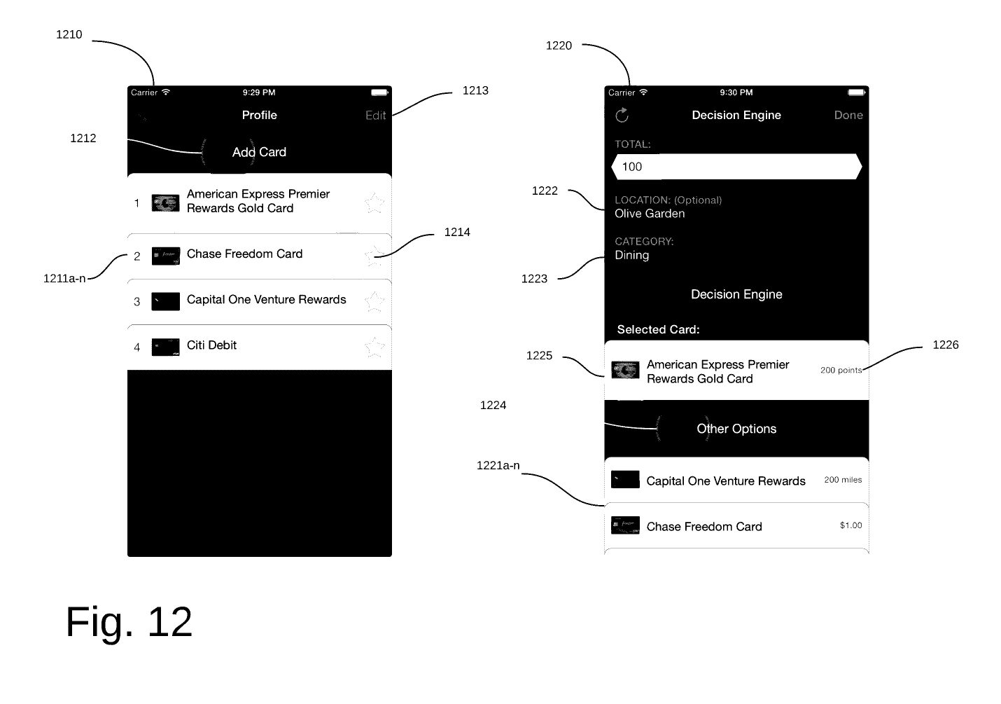

FIG. 12 is a diagram of an exemplary graphical user interface for a transaction-based rewards optimization system, showing a wallet view 1210 and a decision engine screen 1220. In a wallet view 1210, a user may view cards 1211a-n to their electronic wallet, where they may be stored for reference and use in optimization operations. Cards may be added via an interactive button or other element 1212 or edited using an edit button 1213. In another embodiment, edit button 1213 may be used to manually rank cards (for example, favorite cards, cards to enable objective-based travel, and the like). In this regard, when there are, for example, two cards that are ranked by dynamic priority subsystem 521 having a similar reward amounts, by manually ranking cards via edit button 1213, dynamic priority subsystem 521 may use manual ranking to resolve any potential conflicts. In another embodiment, an entry may be added/removed using mobile device gestures known in the art (for example, swiping left or right). A user may also select preferred cards via interactive tagging elements 1214, for example to identify cards they prefer to use when there is not an objective-driven optimization that selects another card, or to manually prioritize similar cards such as gift cards for vendors so that they may be used in a selected order.

In a decision engine screen 1220, a user may view a number of selected cards 1221a-n based on optimization, for example based on their current location 1222 (for example, to select cards that are particularly desirable at nearby vendors), or based on the type of nearby vendors or a current transaction 1223. A user may optionally specify additional preferences 1224, for example to specify that they do not wish to use a particular card for this transaction or that they want to prioritize differently for the current or future transaction in a particular location or with a vendor. User may then select a card 1225 for use to complete a transaction. A user may optionally be presented with a current or predicted total of rewards points 1226 or other rewards metrics, for example to show the user “what they may earn” by using particular cards, or to provide a brief account review so they may see their current status or progress toward a goal.

FIG. 13 is a diagram of an exemplary graphical user interface for a transaction-based rewards optimization system, showing a bill split interface 1310 and a transaction completion summary view 1320. In a bill split interface 1310, a user may be presented with a number of configurable options or parameters to specify the details of a transaction, for example including (but not limited to) a transaction total 1311, a preselected or configurable tip such as a fixed-rate or variable percentage 1312 or a particular dollar amount 1313, a summary of the new transaction total 1314 including a selected tip amount, a number of individuals splitting the transaction 1315, and a total predicted cost for the user 1316 based on the specific amounts and number of people splitting the bill. In this manner, a user may quickly view and edit a transaction's details, and easily see what their individual cost will be after taking into consideration all the specific factors, expediting the bill-splitting process.

In a transaction summary view 1320, a user may review a recently-completed or historical transaction, for example immediately after a purchase or while reviewing a transaction history for their account or a particular card, vendor, or transaction type (for example, viewing all past “food” transactions). A summary 1320 may display a number of metrics, such as including (but not limited to) a card or account used 1321, a button 1322 to view additional history or other details, or reward summary information 1323 such as points or other reward types earned, optionally for a particular transaction or as a cumulative account summary.

In some embodiments, system 500 may reside entirely on end-user device 550 wherein the interfaces presented on FIGS. 11-13 are the interfaces used by the end-user of end-user device 550.

The skilled person will be aware of a range of possible modifications of the various embodiments described above. Accordingly, the present invention is defined by the claims and their equivalents.

What is claimed is:

1. A system for transaction-based rewards optimization and intelligent account selection, comprising:
a network-connected optimization and intelligent account selection computer comprising at least a plurality of programming instructions stored in a memory and operating on a processor, the programming instructions configured to optimize and select accounts to maximize rewards comprising:
a social network manager to receive a plurality of connections from a plurality of end-user devices to register users;
a user configuration database to receive at least user preferences and to configure social connections to a plurality of registered users;
a reward objective database to receive at least a plurality of configured user objectives for reward redemption;
a location identification module to receive a geographic location of a first end-user device;
an optimization manager to receive at least a plurality of transaction information, the geographic location of a first end-user device, and a plurality of rewards program information via a network, the rewards program information comprising at least a plurality of user account details, and configured to compare at least a portion of the transaction information with at least a portion of the rewards program information and the location information configured to produce a plurality of optimized rewards program selections based at least in part on the comparison results; and
a dynamic priority subsystem to receive at least a plurality of optimized rewards program selections and at least a plurality of priority preferences, and configured to order at least a portion of the optimized rewards program selections based at least in part on at least a portion of the priority preferences.

2. The system of claim 1, further comprising a reward matrix subsystem to compare at least a first portion of the plurality of rewards program information against a second portion of the plurality of rewards program information, and configured to produce a plurality of rewards program relationships based at least in part on the comparison results.

3. The system of claim 2, wherein at least a portion of the optimized program selections are based at least in part on at least a portion of the plurality of rewards program relationships.

4. The system of claim 2, wherein the second portion of the reward matrix subsystem identifies a partner reward program corresponding to a first configured user objective.

5. The system of claim 2, wherein the second portion of the reward matrix subsystem identifies a gift card corresponding to a commercial establishment at the geographic location of the first end-user device.

6. The system of claim 1, wherein the geographic location of the first user-device represents a geographic location of a particular commercial establishment.

7. The system of claim 1, wherein the geographic location of the first user-device represents a foreign location.

8. A server for transaction-based rewards optimization and intelligent account selection, comprising:
a network-connected optimization and intelligent account selection computer comprising at least a plurality of programming instructions stored in a memory and operating on a processor, the programming instructions configured to optimize and select accounts to maximize rewards comprising:
a social network manager to receive a plurality of connections from a plurality of end-user devices to register users;
a user configuration database to receive at least user preferences and to configure social connections to a plurality of registered users;
a reward objective database to receive at least a plurality of configured user objectives for reward redemption;
a location identification module to receive a geographic location of a first end-user device;
an optimization manager to receive at least a plurality of transaction information, the geographic location of a first end-user device, and a plurality of rewards program information via a network, the rewards program information comprising at least a plurality of user account details, and configured to compare at least a portion of the transaction information with at least a portion of the rewards program information and the location information configured to produce a plurality of optimized rewards program selections based at least in part on the comparison results; and
a dynamic priority subsystem to receive at least a plurality of optimized rewards program selections and at least a plurality of priority preferences, and configured to order at least a portion of the optimized rewards program selections based at least in part on at least a portion of the priority preferences.

9. The system of claim 8, further comprising a reward matrix subsystem to compare at least a first portion of the plurality of rewards program information against a second portion of the plurality of rewards program information, and configured to produce a plurality of rewards program relationships based at least in part on the comparison results.

10. The system of claim 8, wherein at least a portion of the optimized program selections are based at least in part on at least a portion of the plurality of rewards program relationships.

11. The system of claim 9, wherein the second portion of the reward matrix subsystem identifies a partner reward program corresponding to a first configured user objective.

12. The system of claim 9, wherein the second portion of the reward matrix subsystem identifies a gift card corresponding to a commercial establishment at the geographic location of the first end-user device.

13. The system of claim 8, wherein the geographic location of the first user-device represents a geographic location of a particular commercial establishment.

14. The system of claim 8, wherein the geographic location of the first user-device represents a foreign location.

15. A method for transaction-based rewards optimization and intelligent account selection, comprising:
deploying a network-connected optimization and intelligent account selection computer comprising at least a plurality of programming instructions stored in a memory and operating on a processor, the programming instructions configured to optimize and select accounts to maximize rewards comprising the steps of:
receiving, at a social network manager, a plurality of connections from a plurality of end-user devices to register users;
receiving, at a user configuration database, at least user preferences and configuring social connections to a plurality of registered users;
receiving, at a reward objective database, at least a plurality of configured user objectives for reward redemption;
receiving, at a location identification module, a geographic location of a first end-user device;
receiving, at an optimization manager, at least a plurality of transaction information, the geographic location of a first end-user device, and a plurality of rewards program information via a network, the rewards program information comprising at least a plurality of user account details, and configured to compare at least a portion of the transaction information with at least a portion of the rewards program information and the location information configured to produce a plurality of optimized rewards program selections based at least in part on the comparison results; and
receiving, at a dynamic priority subsystem, at least a plurality of optimized rewards program selections and at least a plurality of priority preferences;
ordering, at the dynamic priority subsystem, at least a portion of the optimized rewards program selections based at least in part on at least a portion of the priority preferences.

16. The method of claim 15, further comprising the steps of:
comparing, using a reward matrix subsystem, at least a portion of the plurality of rewards program information against a second portion of the plurality of rewards program information;
producing, using a reward matrix subsystem, a plurality of rewards program relationships based at least in part on the comparison results, at least a first portion of the rewards program information against at least a second portion of the rewards program information;
producing at least a plurality of rewards program relationships based at least in part on the comparison results; and
producing at least a plurality of optimized rewards program selections based at least in part on at least a portion of the plurality of rewards program relationships.

17. The method of claim 16, wherein the second portion of the reward matrix subsystem identifies a partner reward program corresponding to a first user objective.

18. The method of claim 16, wherein the second portion of the reward matrix subsystem identifies a gift card corresponding to a commercial establishment at the geographic location of the first end-user device.

19. The method of claim 15, wherein the geographic location of the first user-device represents a geographic location of a particular commercial establishment.

20. The method of claim 15, wherein the geographic location of the first user-device represents a foreign location.
